(19) United States
(12) Patent Application Publication
(10) Pub. No.: US 2012/0157122 A1
(43) Pub. Date: Jun. 21, 2012

(54) MOBILE COMMUNICATION DEVICE FOR RETRIEVING GEOSPATIAL DATA

(75) Inventors: Karthigesu NIRANJAN, Ottawa (CA); Russell Norman OWEN, Waterloo (CA)

(73) Assignee: RESEARCH IN MOTION LIMITED, Waterloo (CA)

(21) Appl. No.: 12/971,109

(22) Filed: Dec. 17, 2010

(51) Int. Cl. H04W 24/00

(52) U.S. Cl. 455/456.2

(57) ABSTRACT

A method for receiving geospatial data using a communication device, the method comprising transmitting from the communication device to a server a request for geospatial data, the request including device display information, and receiving at the communication device from the server a subset of requested geospatial data, the subset being generated based on the device display information. The device display information may include a viewport size or a screen size.

### TECHNICAL FIELD

The present technology relates generally to mobile communication devices and, in particular, to mobile communication devices that are capable of retrieving geospatial data.

### BACKGROUND

Electronic maps have gained huge popularity over the years. Rather than dealing with paper-based maps, many technology-savvy users consult electronic mapping services via web browsers to search for addresses, find points of interest or obtain driving directions. Electronic maps may include additional information such as information about businesses, points of interest, schedules, shopping information and other relevant information that may be of interest to the user. For example, the user may be able to locate the nearest coffee shop or bus stop from his or her current location.

However, one of the shortcomings of conventional electronic mapping technology is that the server responding to the user's request sends geospatial data that may not be relevant to the user's current status. For example, if the user request information about a nearby coffee shop and the server finds several coffee shops within a defined threshold (e.g. 50 km of the user), conventional electronic mapping technologies typically send all the retrieved information (i.e. all the geospatial data) within the defined threshold. This unnecessarily uses up the limited resources of the mobile communication device and creates inefficiencies. Thus, there is a need for techniques for optimizing the retrieval of geospatial data.

### BRIEF DESCRIPTION OF THE DRAWINGS

These and other features of the present technology will become more apparent from the following description in which reference is made to the appended drawings wherein:

FIG. 1 is a schematic depiction of a mobile device as one example of a communication device on which the present technology may be implemented;

FIG. 2 is a block diagram of a communication system in which an example implementation of the present technology may be implemented;

FIG. 3 is a flowchart outlining main steps of a method performed by the communication device in retrieving geospatial data;

FIG. 4 is a flowchart outlining main steps of a method performed by a server in responding to a request for geospatial data;

FIG. 5A shows an example of a mobile device requesting geospatial data for a specific address in accordance with one implementation of the present technology;

FIG. 5B shows an example of a mobile device with a map inside a window or dialog box as an example of a viewport that is smaller than the screen size of the device;

FIG. 6A shows another example of a mobile device requesting directions in accordance with one implementation of the present technology;

FIG. 6B shows an example of a map that is displayed on a mobile device in response to the direction request of FIG. 6A;

FIG. 6C shows a variant of the map of FIG. 6B in which the geographic location of the user and a directional/navigation arrow are also shown on the map; and

FIG. 7 shows another example of a mobile device presenting points of interest.

### DETAILED DESCRIPTION

In general, the present technology relates to a novel method, communication device and computer-readable medium for efficiently retrieving geospatial data from a server. By transmitting device display information about the size of the display screen and/or the size of the viewport, the server can provide geospatial data to the communication device that is optimized for the screen size and/or viewport. Upon receipt of the device display information, the server trims or truncates the available geospatial data to create a subset of the requested geospatial data by taking into consideration the device display information. The server may also take into consideration other factors communicated to the server by the communication device such as the current geographic location of the communication device. The server may also resolve any network links and identify any redundant data (e.g. repeated sets of data) by attributing a unique identifier. These techniques reduce the amount of data that is delivered, which is particularly important for mobile devices with restricted over-the-air bandwidth. The server may also transcode geospatial data from its original rich format, e.g. KML to a lighter, more transport-efficient format.

One aspect of the present technology is a method for receiving geospatial data using a communication device. The method entails transmitting from the communication device to a server a request for geospatial data, the request including device display information, and receiving at the communication device from the server a subset of requested geospatial data, the subset being generated based on the device display information.

In one implementation, the device display information includes a viewport size and/or a screen size.

In another implementation, the method involves resolving at the server a network link contained within the requested geospatial data.

Another aspect of this technology is a communication device for retrieving geospatial data, the communication device comprising a requesting module for transmitting a request for geospatial data to a server, the request including device display information, and a communication module for receiving a subset of requested geospatial data from the server, the subset being generated based on the device display information.

Another aspect of this technology is a computer-readable medium comprising instructions in code which when loaded into a memory and executed by a processor of a communication device causes the communication device to request geospatial data by sending to a server a request that includes device display information, and receive a subset of requested geospatial data from the server, the subset being generated based on the device display information.

The details and particulars of these aspects of the technology will now be described below, by way of example, with reference to the attached drawings.

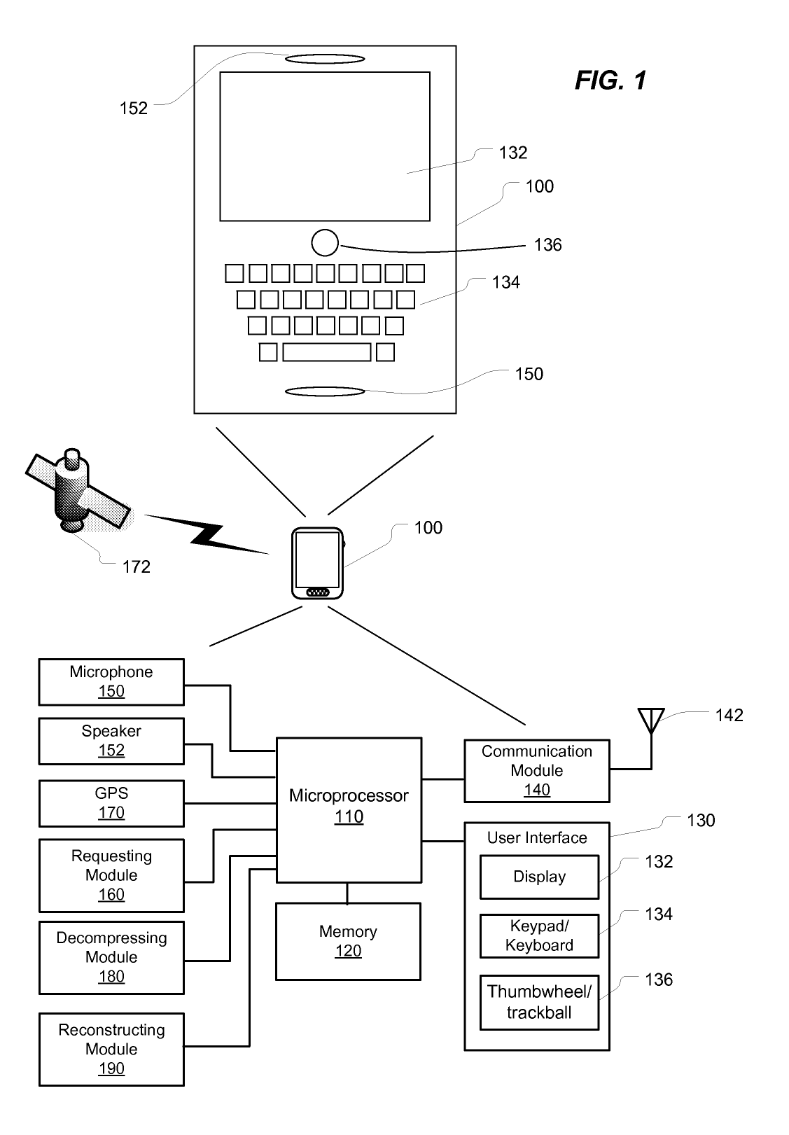

FIG. 1 is a schematic depiction of a mobile communication device 100 as one example of a communication device on which the present technology may be implemented. It should be expressly understood that this figure is intentionally simplified to show only certain main components. The communication device 100 may include other components beyond what is illustrated in FIG. 1. Moreover, while the communication device 100 is depicted as having generally the proportions of a smart phone, it may be any other portable and non-portable device, such as for example a laptop, tablet, or personal entertainment device.

As illustrated in FIG. 1, the communication device 100 includes a microprocessor 110 (or simply a “processor”) that interacts with memory 120. The memory 120 may be in such forms as random access memory (RAM), flash memory, hard disk drives, solid state drives, or any other forms contemplated by a person skilled in the art. The communication device 100 further includes a user interface 130, which may include one or more types of interface such as display 132, keypad or keyboard 134, and thumbwheel or trackpad 136. The communication device 100 may also include a USB port or serial port for connecting peripheral equipment. The device 100 may also include a Wi-Fi transceiver, Bluetooth® transceiver or other short-range wireless transceivers.

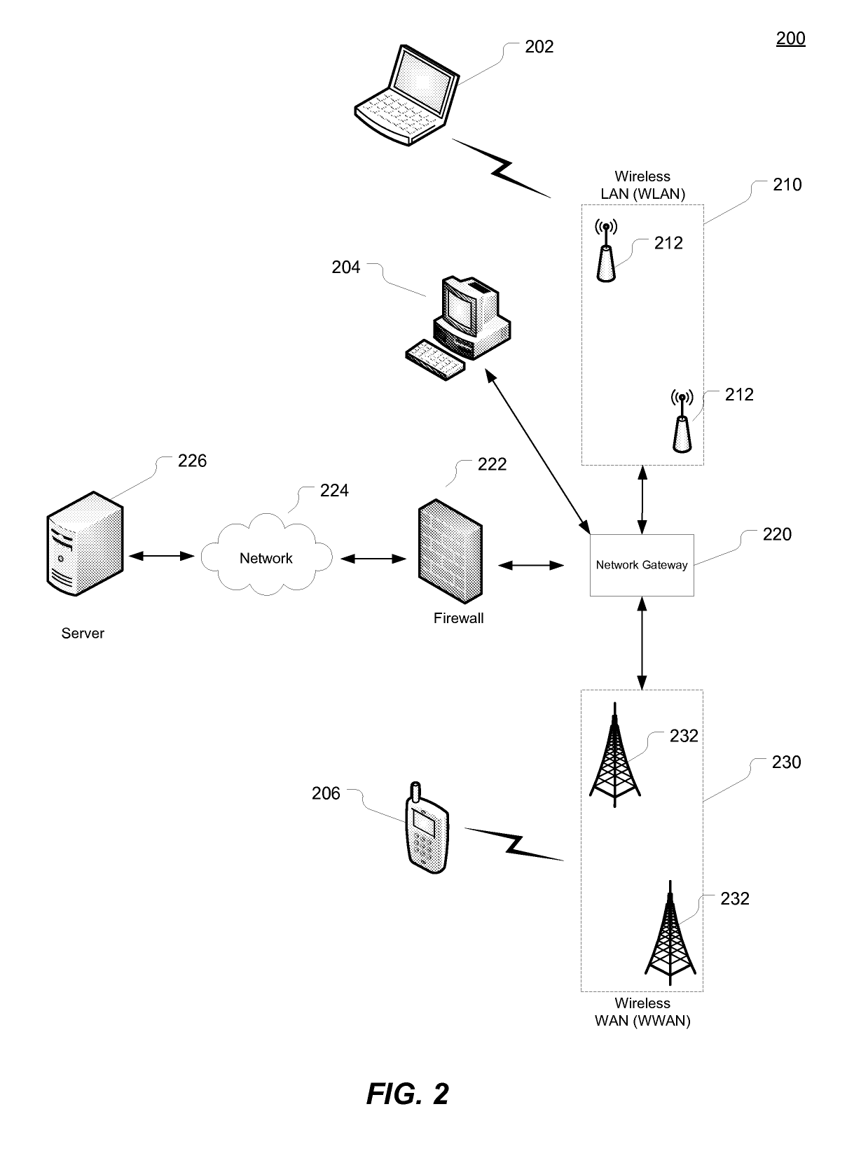

The communication device 100 also includes a communication module 140 for communicating with one or more base stations (e.g. for telephone communication). The communication module 140 is also used to communicate with a server (e.g. 226 in FIG. 2) for retrieving geospatial data. Where the communication device 100 is a wireless communication device, the communication device 100 may include an antenna 142. Where the communication device 100 is a mobile telephone device, cell phone, mobile phone or smart phone, it may include a microphone 150 and a speaker 152.

Furthermore, the communication device 100 also includes a requesting module 160 for requesting geospatial data. The requesting module 160 generates the request to the server for geospatial data, with the request including device information from the communication device 100. The device information may be device display information such as the viewport size or the screen size. The requesting module 160 may be implemented as a separate hardware component in the communication device 100 or may be software code residing in memory 120 for execution by the microprocessor 110.

The communication device 100 may also include a positioning system such as a Global Positioning System (GPS) 170 for receiving GPS radio signals transmitted from one or more orbiting GPS satellites 172.

Although the present disclosure refers expressly to the “Global Positioning System”, it should be understood that this term and its abbreviation “GPS” are being used expansively to include any satellite-based navigation-signal broadcast system, and would therefore include other systems used around the world including the Beidou (COMPASS) system being developed by China, the multi-national Galileo system being developed by the European Union, in collaboration with China, Israel, India, Morocco, Saudi Arabia and South Korea, Russia's GLONASS system, India's proposed Regional Navigational Satellite System (IRNSS), and Japan's proposed QZSS regional system.

The communication device 100 may optionally include a decompressing module 180, for decompressing compressed information received from the server, and a reconstructing module 190, for reconstructing multiple occurrences in the received geospatial data that have been substituted with a unique identifier, as it will be explained in greater detail below. The decompressing module 180 and reconstructing module 190 may be implemented as a separate hardware component in the communication device 100 or may be software code residing in memory 120 for execution by the microprocessor 110

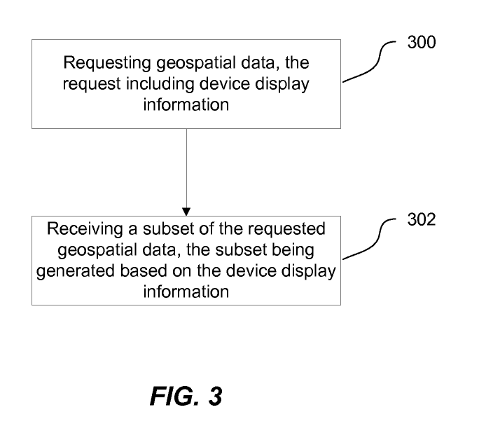

As it will be described below, the communication device 100 communicates with the server (e.g. 226 in FIG. 2) to request and receive geospatial data. Referring to FIG. 1 and FIG. 3, at step 300, the communication device 100 requests geospatial data, for example in Keyhole Markup Language (KML) format, from the server (e.g. 226 in FIG. 2). The request may be, for example, to locate a certain address, request driving directions, or search for a point of interest. Within the request, the communication device 100 includes device display information such as viewport size, display size (screen size), screen resolution, screen type, zoom level, map layers, map filters, or other such information. Optionally, the request may include a geographic location (e.g. position coordinates) or any other information related to the communication device 100. In response to the request, the map server determines all available map data for the area of interest corresponding to the request. The map server then generates, using the information in the request, a subset of this data and provides this subset of data to the communication device. Generating the subset of geospatial data to be returned to the communication devices therefore means culling (i.e. trimming or truncating) some map data that would otherwise be delivered using conventional techniques.

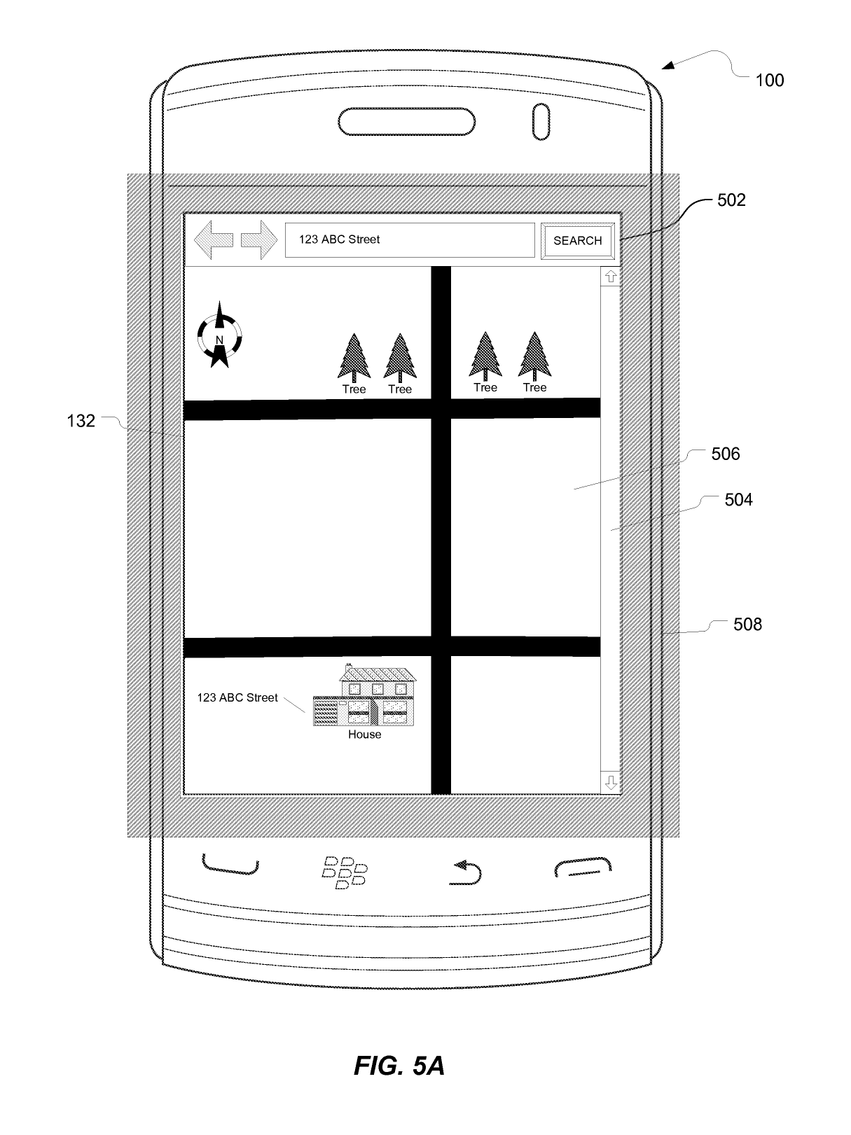

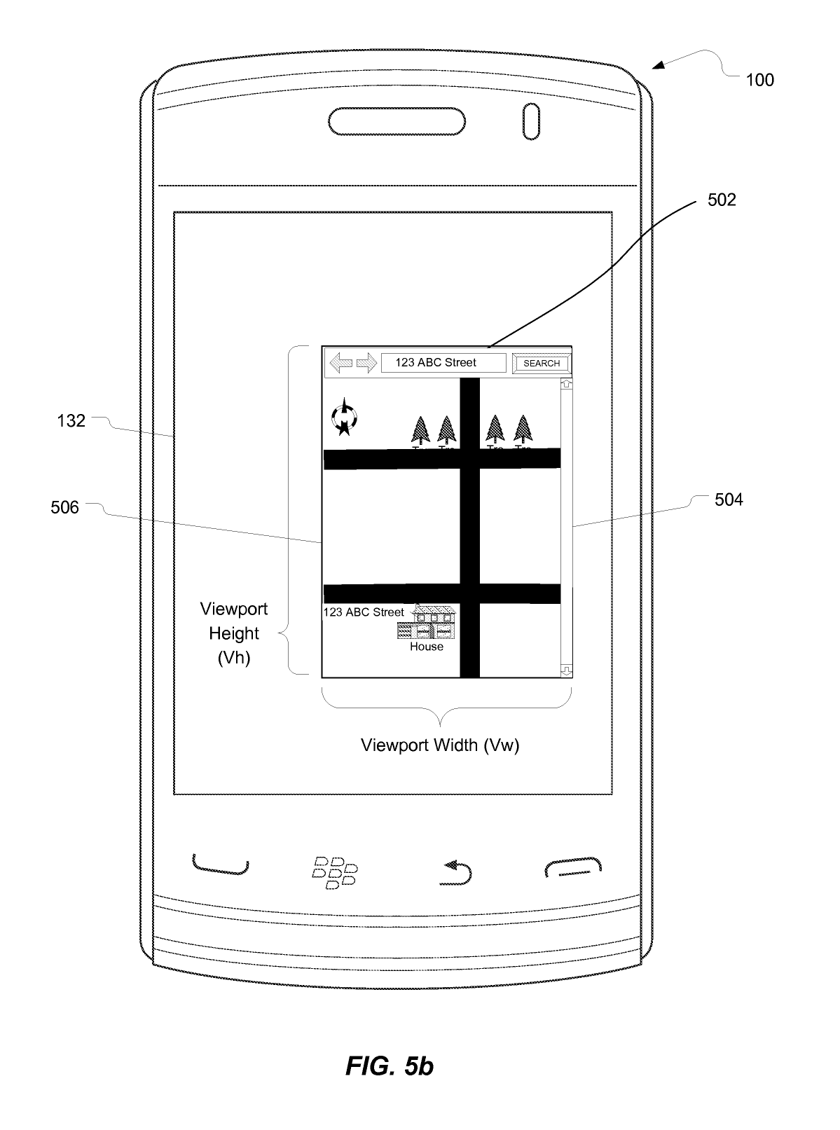

For example, the request may include device display information such as the viewport size of the communication device 100. Viewport is the actual viewable area on the communication device 100. For example, the communication device 100 may be running a GPS mapping application in a “windowed” mode that has a viewport size that is smaller than the actual size of the display 132 as shown by way of example in FIG. 5B. The viewport may, in such an example, be a window or dialog box displayed onscreen, and may be layered over other such windows or dialog boxes. However, the viewport size is not limited to being smaller than the actual size of the display 132. The viewport size may, in some instances, be equal to or greater than the actual size of the display 132.

Optionally, the request may also include a delimiter. A delimiter is any extra condition that the server may utilize when creating or generating a subset of the requested geospatial data. For example, in addition to the viewport information, the request may include a delimiter specifying an amount of surrounding map area or “margin” that is to be included in the returned geospatial data. For example, the delimiter may specify that an additional marginal area equal to a specific percentage of the viewport area is to be included in the returned geospatial data. For example, the device may specify that a surrounding area (margin) equal to an extra 10% of the viewport size is to be retrieved. Thus, with this example request, the server 226 creates a subset of the requested geospatial data that includes map data for the viewport area plus surrounding map data for the margin or border area surrounding the viewport area. The area of the margin in this example is equal to 10% of the viewport area.

In one specific implementation, the request includes any one or more of the device's display size (i.e. its screen size), the device's current geographic location and its current viewport size.

In another implementation, the request may include, as the device information, the zoom level of the communication device 100. Because the zoom level may not necessitate detailed views of the city, the request may further include a delimiter to limit the map layer information, such as only road-level information. Thus, with this request, the server 226 creates a subset of the requested geospatial data that only includes the road-level information within the viewport size of the communication device 100. This eliminates excess information from being communicated between the communication device 100 and the server 226.

Now turning to FIG. 2, there is shown a block diagram of a communication system 200 on which the present technology can be implemented. It should be expressly understood that this figure is intentionally simplified to show only certain main components. The communication system 200 may include other components beyond what is illustrated in FIG. 2.

The communication system 200 includes a number of communication devices 202, 204, 206 which may be connected to the communication system 200 in any of several different ways. Accordingly, several different examples of communication devices 202, 204, 206 are depicted in FIG. 2, each employing a different way of connecting to the communication system 200. Communication devices 202, 204, 206 are connected to the server 226 using wired or wireless technologies or both.

For communication device 202, connection to the server 300 may be established using wireless LAN (WLAN) 210. WLAN 210 may be implemented as any suitable wireless access network technology. By way of example, but not limitation, WLAN 210 may be implemented using IEEE 802.11x standards (sometimes referred to as Wi-Fi) such as, for example, the IEEE 802.11a, 802.11b, 802.11g, and/or 802.11n standard. Other communication protocols may be used for the WLAN 210 in other example implementations such as, for example, IEEE 802.16e (also referred to as Worldwide Interoperability for Microwave Access or “WiMAX”), or IEEE 802.20 (also referred to as Mobile Wireless Broadband Access).

The WLAN 210 includes one or more wireless RF Access Points (AP) 212 (two of which are shown in FIG. 2) that collectively provide a WLAN coverage area. The WLAN 210 is then connected to the network gateway 220 for communication with the server 226.

For communication device 204, connection to the server 226 is established using wired technologies such as IEEE 802.3 standard. Other wired communication technologies may be contemplated by a skilled person in the art.

For communication device 206, connection to the server 226 is established using wireless WAN (WWAN) 230. By way of example, but not limitation, the WWAN 230 may be implemented as a wireless network that includes a number of transceiver base stations 232 (two of which are shown in FIG. 2) where each of the base stations 232 provides wireless Radio Frequency (RF) coverage to a corresponding area or cell. In some example implementations, the WWAN 230 may use the following network technologies: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) CDMA1010, EDGE (Enhanced Data rates for GSM Evolution), UMTS (Universal Mobile Telecommunication Systems), HSPDA (High-Speed Downlink Packet Access), IEEE 802.16e (also referred to as Worldwide Interoperability for Microwave Access or “WiMAX), or various other network technologies. Although WWAN 230 is described as a “Wide-Area” network, that term is intended herein also to incorporate wireless Metropolitan Area Networks (WMAN) and other similar technologies for providing coordinated service wirelessly over an area larger than that covered by typical WLANs.

Using wireless or wired technologies, communication devices 202, 204, 206 connect to the network gateway 220. The internal network 224 is typically behind a firewall 222, which serves to safeguard the internal network 224 from unauthorized access. Only authorized communication devices 202, 204, 206 are granted access to the server 226.

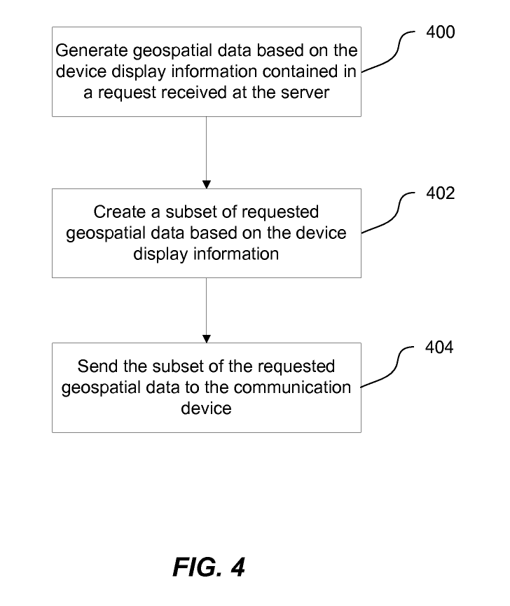

Now turning to FIG. 4, a flowchart illustrates main steps performed by the server 226 in one implementation of this technology. When the server 226 receives a request for geospatial data from the communication device 100, the server 226 generates geospatial data based on the request from the communication device 100 (i.e. step 400 in FIG. 4). This request may be, for example, a request to locate a certain address, a request for driving directions, or a request to search for a point of interest. The server then generates, obtains or assembles geospatial data for an area of interest that corresponds to the request. The generated geospatial data includes all the necessary information pertaining to the request. The generated geospatial data may be pre-processed information. After generating the geospatial data, the server 226 creates a subset of the generated geospatial data based on the device display information that was included in the request (i.e. 402 in FIG. 4). As previously described, the request includes device display information and, optionally, a delimiter that is used by the server 226 to create the subset. For example, the requesting module 160 may have included a delimiter such as map layer information.

The subset may also be created from other device information such as the geographical location of the communication device 100 provided by the GPS 170. For example, if it is determined that the communication device 100 is currently on a highway, the requesting module 160 may include a delimiter that limits the geospatial information to road-level detail only.

Thereafter, the subset of the generated geospatial data is sent to the communication device 100. This reduces the amount of data that is communicated between the communication device 100 and the server 226. In one implementation, all or a portion of any remaining generated geospatial data that has been excluded from the subset may be stored at the server for quick access in subsequent requests.

Optionally, the server 226 may resolve network links (e.g. KML network links) included in the requested geospatial data. By resolving the network links at the server 226, the server 226 is able to determine whether the information found at the network link is relevant to the device information. This eliminates the need for the communication device 100 to download the information found at the network link that is currently irrelevant. For example, if the network link refers to an image, which is currently not displayable on the communication device 100, the server 226 excludes the information from the subset. However, the image found at the network link may be downloaded and stored at the server 226 for faster retrieval during subsequent requests. In the specific context of KML/KMZ data files, resolving these network links at the server enables the server to determine which content to immediately deliver to the communication and which content to cache.

Additionally, or alternatively, the server 226 may extract multiple occurrences of data contained within the generated geospatial data. For example, if the generated geospatial data includes network links that refer to the same image, the server 226 may extract the multiple occurrences to avoid repeat data from being downloaded by the communication device 100. In its place, the server 226 may insert a unique identifier that can be used by the communication device 100 to reconstruct the original geospatial data. In the above example, in place of the repeated image, a unique identifier may be inserted to refer back to the first instance of the repeated image. When the communication device 100 receives the subset, the reconstructing module (i.e. 190 in FIG. 1) reconstructs the original geospatial data by using the unique identifier.

In a further implementation, the server 226 may compress the subset of the geospatial data prior to transmission to the communication device 100 using any compression technology known to the person skilled in the art. When the communication device 100 receives the compressed subset, the decompressing module (i.e. 180 in FIG. 1) decompresses the compressed subset to obtain the original geospatial data.

Specific examples of the present technology will now be described in details.

### Specific Address

In one example use of the present technology, the communication device 100 may be used to look up a specific address, such as address “123 ABC Street”. As shown in FIG. 5A, the display 132 shows a user interface including a search bar 502 and scroll bar 504. The result of the search is displayed in the viewable portion of the user interface, which is viewport 506. As it can be seen, the viewport 506 is smaller than the actual display 132. In this particular example, only one full block of the neighbourhood may be displayed in the viewport 506; thus, when the communication device 100 requests geospatial data relating to address search, viewport information (i.e. device information) is included in the request.

When the server 226 receives the request, geospatial data relating to the address search is first generated. The generated geospatial data includes all surrounding information and map details. The generated geospatial data may also be pre-processed based on an agreed standard for a particular map information provider. However, while pre-processed information may be quickly generated on the server 226, the communication device 100, nonetheless, has to download all the generated geospatial information that is unrelated to the device information. The present technology therefore reduces the usage of bandwidth and minimizes the impact on processing and memory resources.

In addition to resolving network links, the server may also transcode geospatial data from its original (rich) format, e.g. KML/KMZ, to a lighter, more transport-efficient format. Transcoding of geospatial data from an original format such as KML/KMZ to an efficient wireless transport format may be done at the network gateway 220.

According to the present technology, the communication device 100 includes, in the request, device information. After generating the geospatial data, the server 226 uses the device information to create a subset of the generated geospatial data. In this particular example, the request includes the size of the viewport 506. Thus, any generated geospatial information that is outside of the viewport size 506 would be left out of the subset. This allows the retrieved data to be quickly accessed from the server, rather than from the Internet or any other public or private network.

Additionally, the communication device 100 may include a delimiter relating to the surrounding information. For example, the communication device 100 may request geospatial data for the viewport size 506 and a predetermined margin, marginal area, band, frame or border around the viewport size. This may be expressed as a percentage of the viewport size (view port), or as a percentage of the height and a percentage of the width of the viewport. For example, the request may specify the viewport size plus a margin of 10% of the surrounding information (e.g. shaded portion 508 in FIG. 5A). In this particular example, even if the user zooms out of the current zoom level by 10%, the communication device 100 can provide geospatial data without making another request to the server. Any generated geospatial data not part of the subset may be stored (for example in a separate cache) on the server for future access.

Additionally, by way of example, FIG. 5A contains multiple copies of the tree image. These images may be expressed as a network link in the initially generated geospatial data. According to an implementation of the present technology, the server 226 resolves these network links by downloading the information found at the network link (i.e. the tree image) and storing the downloaded information at the server. Thereafter, for each repeated image link, the server 226 may insert a unique identifier to reference to the first image of the tree to reduce the number of copies of the image. This optimizes the amount of information that the communication device 100 has to download from the server 226.

The viewport 506 may be smaller than the display size as shown by way of example in FIG. 5B. In this example, the viewport has a viewport height (Vh) and a viewport width (Vw). The Vh and Vw parameters may be included in the request sent from the communication device to the server. The delimiter may also be expressed in terms of these Vh and Vw parameters. For example, the delimiter in the request may specify that the geospatial data to be retrieved should be Vh plus a height margin of a x percent and Vw plus a width margin of y percent. The device may be configured to automatically obtain the viewport size (or viewport height and width) and to incorporate this into any request that is made for geospatial data.

### Directions

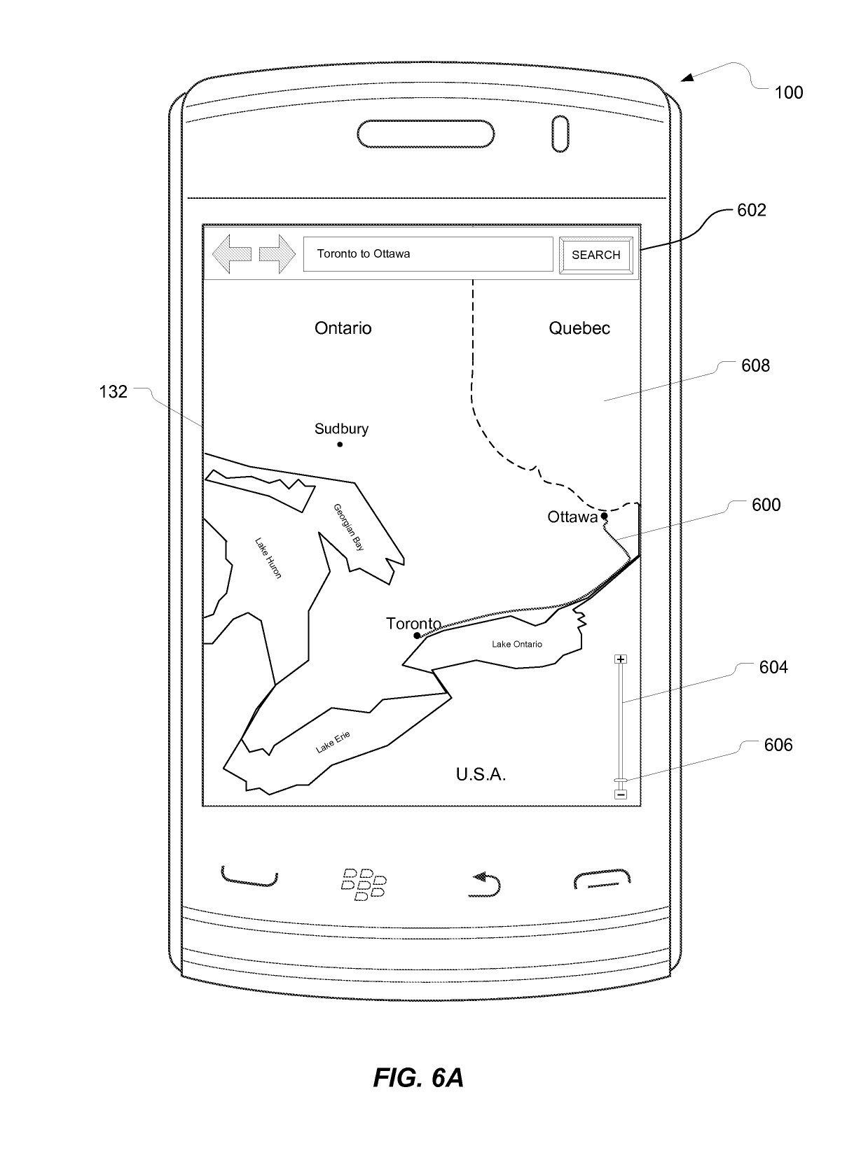

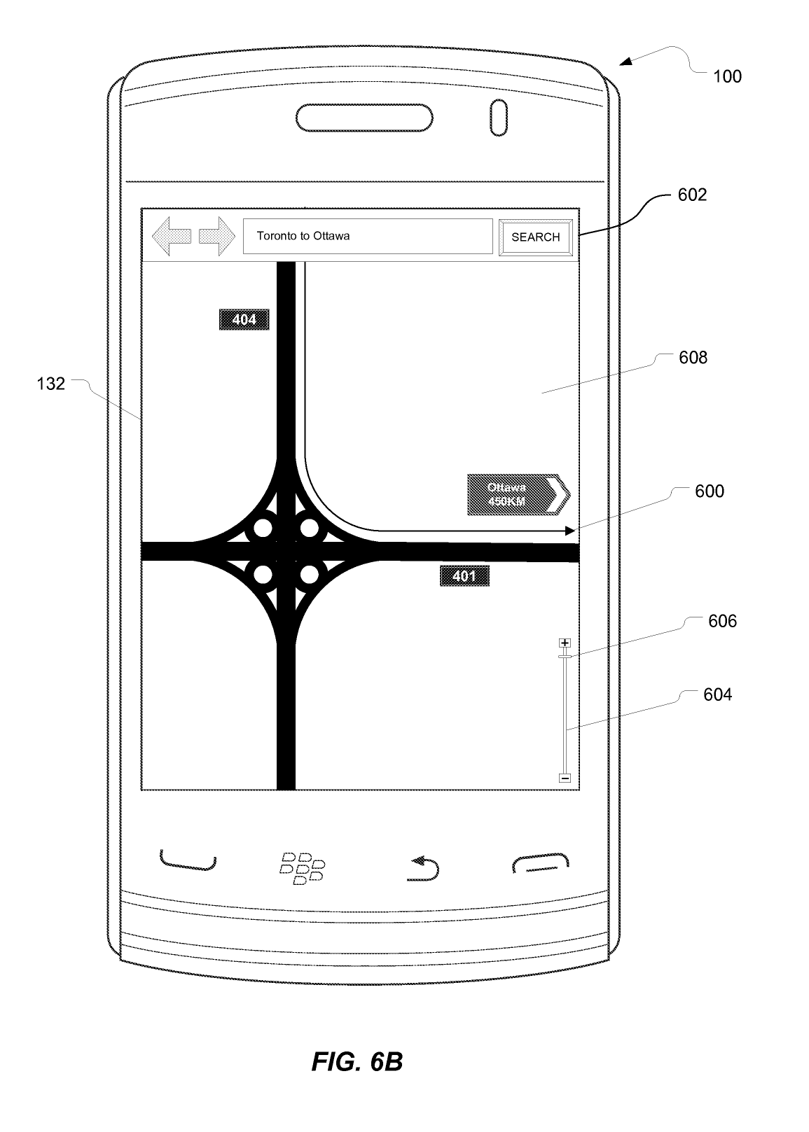

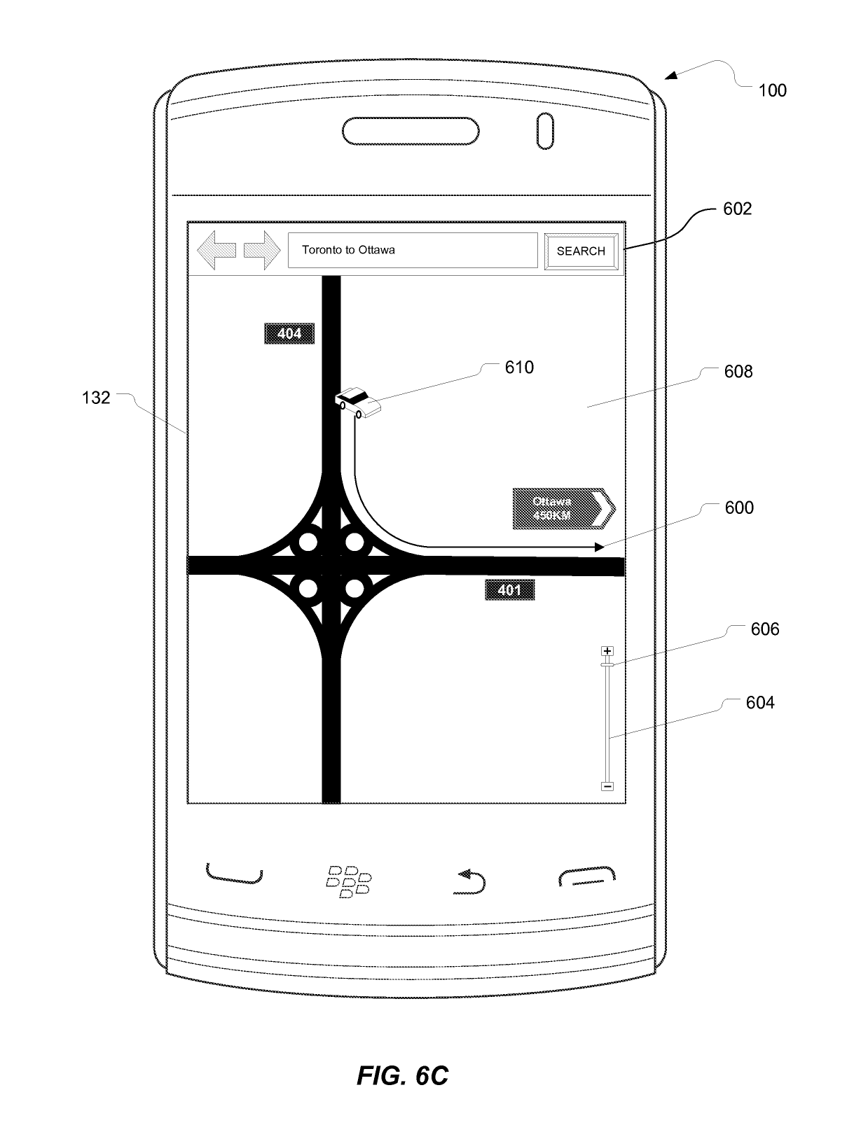

In another example use of the present technology, the communication device 100 may be used to obtain direction from a source to a destination. In FIG. 6A, there is shown, by way of example, a driving direction 600 from Toronto to Ottawa. The user interface includes a search bar 602 and a zoom bar 604. Because of the position of the zoom level 606 of the zoom bar 604, the entire direction from Toronto to Ottawa is shown and downloaded to the communication device 100. Moreover, the generated geospatial data includes all the map layer information such as local roads, even if such information cannot be displayed with the current zoom level 606.

Now referring to FIG. 6B, there is shown, still by way of example, the same driving direction 600 but with the zoom level 606 positioned to show a much more detailed driving direction 600. Using the present technology, the communication device 100 may include information about zoom level 606, in addition to the viewport 608, with the search request. Thus, when the server 226 creates a subset of the generated geospatial data, it is able to take into consideration not only the viewport information but also the zoom level 606. This means that information that lies outside of the viewport 608, taking into account the zoom level 606, would not be included in the subset sent from the server. Moreover, the requesting module 160 of the communication device 100 may include a delimiter to exclude terrain-level details such as rivers and lakes. Because the requested direction 600 is entirely on the highway, the requesting module 160 includes this delimiter to reduce the amount of downloaded information by the communication device 100.

Alternatively, or additionally, the communication device 100 may include the geographic location 610 of the communication device 100 obtained using the GPS (e.g. 170 in FIG. 1) as shown in FIG. 6C. Using this information, the server 226 is able to create a subset of the generated geospatial information to exclude irrelevant information. In this particular example, direction information closer to Ottawa would be irrelevant until the geographic location 610 is near the Ottawa area. Moreover, the requesting module 160 of the communication device 100 may include a delimiter that requests only highway-level information. With such a delimiter, any local road information may be omitted from the subset.

Without the present technology, the information downloaded by the communication device 100 for zoom level 606 or geographic location 610 shown in FIGS. 6A, 6B and 6C would be identical which would waste valuable resources of the communication device 100 and the network.

### Points of Interest

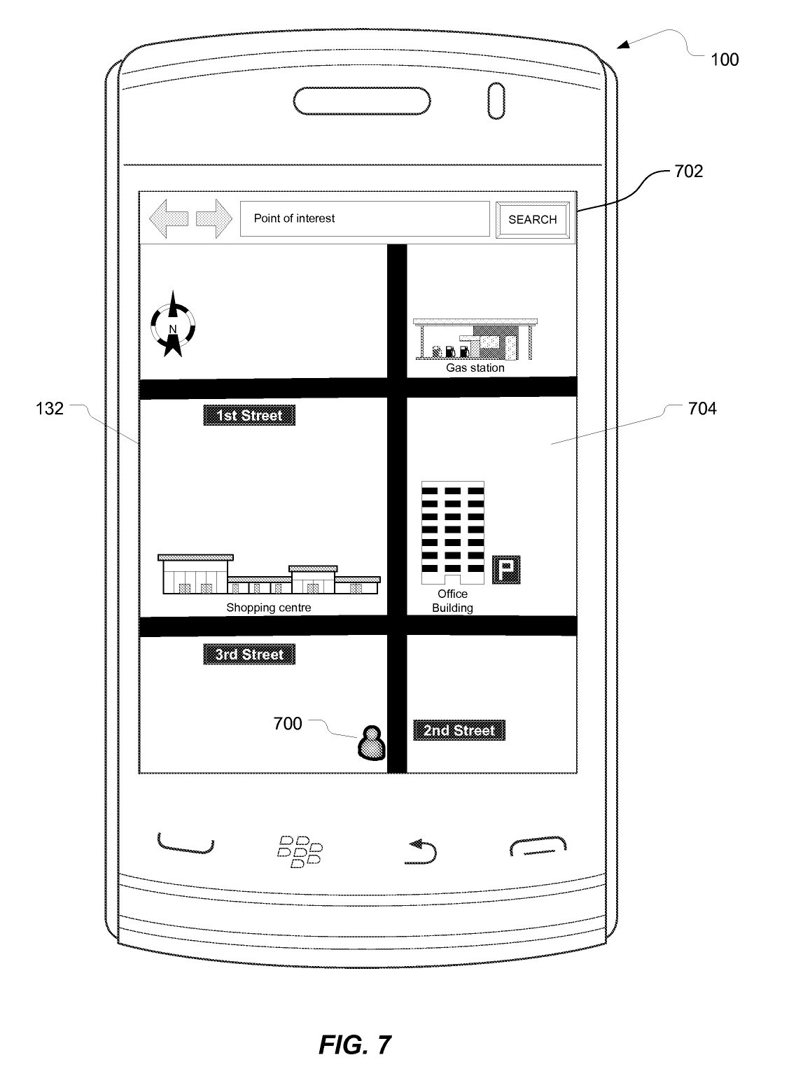

In FIG. 7, there is shown a further exemplary use of the present technology with communication device 100. User 700 walking along “2nd street” searches for points of interest in the search bar 702. As it can be seen, the display 132 has viewport 704 that shows two intersections of the neighbourhood. Displayable within the viewport 704 is a shopping centre, office building and gas station. Any other information would be irrelevant to the current viewport 704. Thus, using the present technology, when the request is made to retrieve the point of interest, the communication device 100 includes the viewport information 704. In addition, the communication device 100 may also include geographical information of the user 700 and other information such as size of the display 132, and zoom level (e.g. 606 in FIG. 6A) of the zoom bar (e.g. 604 in FIG. 6A). With this information related to the device, the server 226 creates a subset of the geospatial data that is pertinent to the device information. In this particular example, a point of interest outside of the viewport 704 would be irrelevant.

The methods disclosed herein may be implemented in hardware, software, firmware or any suitable combination thereof. Implementation in software entails providing coded instructions stored on a computer-readable medium which perform the methods disclosed herein when the computer-readable medium is loaded into memory and executed by the microprocessor of the communication device. A computer-readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer-executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), or any equivalent component.

One or more implementations of the present technology have been described by way of example in the present disclosure. It will be apparent to persons skilled in the art that a number of variations, refinements and modifications can be made without departing from the scope of the present technology as defined in the claims.

In this specification, including the claims of this specification, the singular forms “a,” “an,” and “the” are intended to include plural references unless the context clearly dictates otherwise. Unless defined otherwise, all technical and scientific terms used herein have the same meaning as commonly understood to one of ordinary skill in the art to which this technology belongs. The terms “comprise”, “comprises” or “comprising” indicate the presence of stated features, integers, steps, operations, elements, and/or components, but do not preclude the presence or addition of one or more other features, integers, steps, operations, elements, components, and/or groups thereof.

1. A method for receiving geospatial data using a communication device, the method comprising:
transmitting from the communication device to a server a request for geospatial data, the request including device display information; and
receiving at the communication device from the server a subset of requested geospatial data, the subset being generated based on the device display information.

2. The method according to claim 1, wherein transmitting the request comprises transmitting a viewport size within the request.

3. The method according to claim 1, wherein transmitting the request comprises transmitting a screen size within the request.

4. The method according to claim 1, wherein the request comprises information relating to any one or more of viewport size, geographic location, and screen size of the device.

5. The method according to claim 1, further comprising caching excluded geospatial data at the server, the excluded geospatial data being available map data at the server that has been excluded from the subset.

6. The method according to claim 1, further comprising resolving at the server a network link contained within the requested geospatial data.

7. The method according to claim 6, wherein resolving the network link comprises:
downloading information found at the network link; and
storing the downloaded information at the server.

8. The method according to claim 7, further comprising:
identifying multiple occurrences of data using a unique identifier; and
reconstructing the multiple occurrences at the device using the unique identifier.

9. The method according to claim 8, wherein transmitting the request comprises transmitting a viewport size within the request.

10. The method according to claim 1, wherein transmitting the request comprises transmitting a delimiter within the request, the delimiter specifying an additional margin of map data surrounding the viewport.

11. The method according to claim 10, wherein the delimiter also specifies map layer information.

12. A communication device for retrieving geospatial data, the communication device comprising:
a requesting module for transmitting a request for geospatial data to a server, the request including device display information; and
a communication module for receiving a subset of requested geospatial data from the server, the subset being generated based on the device display information.

13. The device according to claim 12, wherein the device display information comprises a viewport size.

14. The device according to claim 12, wherein the device display information comprises a screen size.

15. The device according to claim 12, further comprising a reconstructing module for reconstructing multiple occurrences of data stored at the server that have been identified by a unique identifier.

16. The device according to claim 12, wherein the request comprises information relating to any one or more of viewport size, geographic location, and screen size of the device.

17. The device according to claim 13, wherein the request further includes a delimiter specifying a margin surrounding the viewport.

18. The device according to claim 17, wherein the delimiter specifies map layer information.

19. A computer-readable medium comprising instructions in code which when loaded into a memory and executed by a processor of a communication device causes the communication device to:
request geospatial data by sending to a server a request that includes device display information; and
receive a subset of requested geospatial data from the server, the subset being generated based on the device display information.

20. The computer-readable medium according to claim 19 wherein the request comprises a viewport size.
